(19) United States
(12) Patent Application Publication
(10) Pub. No.: US 2019/0153777 A1
(43) Pub. Date: May 23, 2019

(54) DUAL SCREEN ROLL BLIND

(71) Applicants: Kim Dae Young, Seoul (KR); WINPLUS Co., Ltd., Chungcheongbuk-do (KR)

(72) Inventors: Tae-Woong Byun, Daejeon (KR); Kim Dae Young, Seoul (KR)

(21) Appl. No.: 15/824,205

(22) Filed: Nov. 28, 2017

(30) Foreign Application Priority Data
Nov. 21, 2017 (KR) 10-2017-0155279

(51) Int. Cl. E06B 9/42; E06B 9/78; E06B 9/60; E06B 9/80

(52) U.S. Cl. CPC E06B 9/42; E06B 9/78; E06B 2009/2452; E06B 9/80; E06B 9/60

(57) ABSTRACT

A dual screen roll blind including two winding roll bodies which are roll-stored respectively so as enable light blocking or light shielding by adjusting vertical positions of two screens, including two selectively draw screens, to rapidly store an unrolled screen through automatic return and ensure child safe by a return spring and a limiter.

### CROSS-REFERENCE TO RELATED APPLICATIONS

This application claims the priority of Korean Patent Application No. 10-2017-0155279 filed on Nov. 21, 2017, in the Korean Intellectual Property Office, the disclosure of which is incorporated herein by reference.

### BACKGROUND

### Field

The present disclosure relates to a dual screen roll blind, and more particularly, to a dual screen roll blind, in which can selectively draw/store two screens more easily than the related art, have both novelty and light transmitting/light shielding property according to a taste of a user, and ensure child safe.

### Description of the Related Art

In general, a roll blind is a device installed on a transparent window or glass wall to block introduction of light from the outside to adjust an atmosphere of a room or to block the room from being visible from the outside.

The roll blind in the related art is a structure in which a single roll screen having the same amount of light transmission as a whole area is wound around one winding rod to block light through drawing/storage or the roll blind is wound up on the winding rod installed at an upper portion of the window and in a method that adjusts a height of the roll screen in order to adjust the light transmission amount of the light and a method that adjusts the light transmission amount by adjusting the height of the roll screen, the light is completely transmitted in a part (a lower part) and the light is completely blocked in another part (an upper part) is completely blocked, and as a result, the light transmission amount may not be uniformly adjusted with respect to a whole surface of the window or the glass wall.

In order to solve such a problem, a method of adjusting the light transmission amount by arranging two roll screens in which a light transmission unit and a light shielding unit are alternately arranged in a horizontal direction or a vertical direction to be arranged to overlap with each other and adjusting an overlapped amount may be presented in the related art.

As such an example, first, a “roll blind” of Patent Document 1 is installed on a window frame and includes a support frame in which a pair of end plates are installed on both left and right ends and includes first and second winding rods rotatably installed on the end plates of the support frame and a winding driver rotatably driving any one of the first and second winding rods.

In addition, the roll blind includes first and second screens individually coupled to the first and second winding rods, a weight bar to which a lower end of each of the first and second screens is fixed, and a clutch unit mutually restraining/releasing the first and second winding rods, the clutch unit includes a gear fixedly coupled to the winding driver and a driven gear in the second winding rod to be restrained/released, an intermediate gear is interposed between the gear and the driven gear, the driven gear has a clutch socket unit having an arc shape on one surface, the clutch socket unit has both ends, a clutch protrusion is provided in the second winding rod, and the clutch protrusion is selectively suspended and contacted to both ends of the clutch socket unit while being guided in the clutch socket unit, and as a result, the driven gear is selectively restrained to or released from the second winding rod.

In such a roll blind in the related art, by operating one ball chain, it is possible to simultaneously open/close the roll screen and adjust the light transmission amount of the roll screen. In particular, an opening/closing structure of the roll screen and a light transmission amount adjustment structure are manufactured in one mechanical structure which is simple and reliable, and as a result, the roll blind is excellent in cost saving effect due to simplification of the structure and the roll blind has excellent durability even by a repeated operation.

As a second example, a technique disclosed in a “dual roll blind” of Patent Document 2 includes the first and second screens each including the light transmission unit and the light shielding unit, includes first and second winding rods winding the first and second screens, respectively and includes a first gear rotatably driving the first winding rod, a second gear which rotates depending on the first gear and rotates the second winding rod, and an engagement holding unit transferring elastic force to at least one of the first gear and the second gear in a direction parallel to a rotary shaft.

Further, the dual roll blind includes a clutch body including the first gear, the second gear, and the engagement holding unit and the clutch body includes a setting hole formed at a position corresponding to the engagement holding unit and has a structure in which at least one of the first and second gears is positioned between the setting hole and the engagement holding unit.

Accordingly, such a dual roll blind in the related art enables adjustment of the light transmission amount of the roll screen and opening/closing of the roll screen by one ball chain and provides an advantage to facilitate initial setting of the roll screen.

However, in the related art, the ball chain used for a user to operate the first and second screens to be wound up and down elongates in an endless track manner, resulting in suffocation due to neck tightening of infants and children.

In addition, in the ball chain of a roll blind device in the related art, which is stretched in an endless track type as described above, a safety accident also often occurs in which a child who is running in the room or a frail elderly person easily falls down on an endless track type cord and is badly injured.

In order to fundamentally prevent such a problem, a length has been restrained through law revision to prevent the ball chains in the related art, which are stretched in the endless track type from being connected to each other and to position the ball chain at a position where the ball chain cannot reach hands of children.

In addition, in the roll blind in the related art, when the lower end of the ball chain is separated to shorten the length thereof and the ball chain is positioned at a height at which the ball chain reaches the hands of the children, a function is not provided in which the ball chain is restored to an original position after the ball chain is pulled so as to adjust the heights of the first and second screens. Therefore, when the ball chain is not of the endless track type, the first and second screens need to be repeatedly operated, so that it takes a long time to draw and store the screen.

Further, in the related art, since the clearance adjustment for adjusting the light transmitting units and the light shielding units of the first and second screens to be aligned with each other or the light transmitting units and the light shielding units to be misaligned with each other is constant, different roll blind devices should be used to adjust the light transmitting units and the light shielding units having different sizes to be aligned with each other or misaligned with each other in the first and second screens having different specifications and the related art has a structure in which it is difficult to universally use the related art for the first and second screens having the light transmitting units and the light shielding units having different sizes by using one device.

### SUMMARY

An object to be achieved by the present disclosure is to provide a dual screen roll blind which includes a gear unit drawing a screen wound on a winding roll by selectively rotating each rotation rod in one direction according to a traveling direction of a ball chain and a support rod provided on an opposite side of the rotation rod and having a return spring which can rapidly store the drawn screen by elastic force to selectively draw the screen according to selection of a user and rapidly store the drawn screen and can use each of two screens to obtain both novelty and a light transmitting/light shielding property, and can ensure child safe by a limiter provided in the winding rod and the return spring.

According to an aspect of the present disclosure, there is provided a dual screen roll blind including two winding roll bodies which are roll-stored so as enable light blocking or light shielding by adjusting vertical positions of two screens. The dual screen roll blind includes: a blind housing including a roll cover installed at an upper portion of a window and having an accommodation space of a predetermined length and the end plates formed at both ends of the roll cover; first and second winding roll bodies accommodated in the receiving space of the roll cover at a distance from each other, and rotatably installed at both ends of the end plates, and roll-storing first and second screens so that the positions of the first and second screens are vertically adjusted; a gear unit provided between the first and second winding roll bodies and either one of the end plates and including a driving gear is installed, which is axially coupled to the first winding roll body and chain-connected to a ball chain to rotatably operate the first winding roll body by rotation driving, a first switching connector provided between the first winding roll body and the driving gear and transferring rotation in only one direction of rotational directions of the driving gear to the first winding roll body, a driven gear receiving rotational force of the driving gear to rotatably operate the second winding roll body by an intermediate gear which is axially coupled to the second winding roll body to gear-engaging the first and second winding roll bodies along the end plate, and a second switching connector provided between the second winding roll body and the driven gear and transferring only the rotational force of the driven gear that rotates in a direction opposite to the rotational direction of the driving gear to the second winding roll body, and the winding roll body divided into the first and second winding roll bodies includes a winding roll drawing and storing the screen having a weight bar by rotating the screen in a roll manner, a winding rod fitted to one end of the winding roll and connected to the driving gear or the driven gear so as to be rotatably operate by the rotational force transferred from the driving gear or the driven gear, and a support rod provided on the opposite end plate in correspondence with the winding rod and supporting the winding roll which rotates while being fitted into the other end of the winding roll, and the roll-stored screen is drawn by rotating the winding roll by the driving gear or the driven gear or by the rotational operation of the winding rod, and the rotational force of the winding roll is accumulated through the return spring incorporated in the support rod, and thereafter, elastically restored to roll-store the screen in the winding roll.

Herein, the winding rod may include sequentially from a switching connector divided into the first and second switching connectors along a central axis, a clutch unit selectively controlling the rotational force only at the time of transferring the rotational force transferred from the driving gear or the driven gear through the switching connector to the winding roll, a stopper unit restraining/releasing a current position of the screen due to restoration force of the return spring when the screen stops at a position desired by the user during a drawing operation of the screen through rotation of the winding roll, and a limit unit completing roll-storing by stopping the rotation of the winding roll when the screen reaches an initial position in the case where the screen is roll-stored by rotating the winding roll due to the restoration force of the return spring through releasing the stopper unit.

In this case, the clutch unit may include a clutch plug fitted into an inner diameter of the winding roll having a cylindrical shape in a socket manner and having a clutch socket unit therein, a rear clutch having a slide key inserted into the clutch socket unit and elastically supported by a support spring, a front clutch engaged with a clutch surface through mutual correspondence to correspond to the rear clutch, and a driving rotation body transferring the rotational force transferred by direct coupling to the switching connector to the front clutch, and when the front clutch is rotated simultaneously with rotation of the driving rotation body with rotation of the switching connector, the slide key of the rear clutch engaged with the front clutch may be fixed in close contact with an inner suspension protrusion of the clutch plug to restrain the switching connector, the driving rotation body, the front clutch, the rear clutch, and the clutch plug by a single body, thereby rotatably operating the winding roll.

In addition, the stopper unit may include a stopper socket unit a stopper body having multiple ball guide grooves having a predetermined length, which form an inner surface in a spline manner at an opposite side of the clutch plug to correspond to the clutch socket unit, a stopper body having a line groove inserted into the stopper socket unit and having a linear section and a suspension section having a geometric stop on the circumference on an outer surface, and a bead-shaped ball key repeatedly restraining/releasing the position of the screen while moving in the linear section and the suspension section in a movement direction of the screen provided in each of the ball guide groove and the line groove and drawn from/stored in the winding roll.

Further, the limit unit may include a screw rod extended from the stopper body in a longitudinal direction and having a thread on an outer circumferential surface thereof, a finishing plate coupled to an end of the screw rod, and a limiter fastened to the screw rod in a nut shape and reciprocating on the thread in the longitudinal direction of the screw rod with rotation of the screw rod, and when the winding roll rotates in order to draw the screen, while the screw rod rotates together, the limiter may perform positional movement of being gradually away from an initial position of the finishing plate along the thread and when the winding roll rotates in a reverse direction by roll-storing the screen, while the screw rod rotates together, the limiter may return to the initial position where the finishing plate is present to stop a storing operation of the screen when the limiter is in contact with the finishing plate.

In this case, a speed reducer reducing a rotational speed of the winding roll may be further provided at the end of the screw rod to which the finishing plate is coupled in order to prevent a safety accident and breakage caused by high-speed rotation of the winding roll and rapid roll-storing of the screen due to the restoring force of the return spring.

Meanwhile, when installing in the window or during using the dual screen roll blind is provided with the end plate, the driving gear or the driven gear, and the first and second winding roll bodies through penetration coupling, a setting adjuster for the user to adjust the screen to the initial position by directly rotating the first and second winding roll bodies may be further provided.

According to the present disclosure, it is possible to selectively draw two screens, to rapidly store an unrolled screen through automatic return and ensure child safe by a return spring and a limiter, and to achieve an increased scarcity value by giving novelty, and a light transmitting property, and a light shielding property of the screen according to a taste of a user.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is an overall configuration diagram illustrating a dual screen roll blind according to the present disclosure;

FIG. 2 is an exploded view illustrating respective components of a winding roll body and a gear unit in the dual screen roll blind of the present disclosure;

FIGS. 3A and 3B are side cross-sectional views illustrating operation states of the winding roll body and the gear unit in the dual screen roll blind of the present disclosure;

FIGS. 4A and 4B are exemplary diagrams illustrating a use state depending on an operation of the gear unit in the dual screen roll blind of the present disclosure;

FIGS. 5A and 5B are exemplary diagrams illustrating the operation state of a clutch unit in the dual screen roll blind of the present disclosure;

FIGS. 6A and 6B and 7A to 7C are exemplary diagrams illustrating installation and operation states of a stopper unit in the dual screen roll blind of the present disclosure; and

FIGS. 8A and 8B are exemplary diagrams illustrating the operation state of a setting adjuster in the dual screen roll blind of the present disclosure.

### DETAILED DESCRIPTION OF THE PREFERRED EMBODIMENT

Hereinafter, an exemplary embodiment will be described in detail with reference to the accompanying drawings so as for those skilled in the same art as the present disclosure to easily carry out the present disclosure.

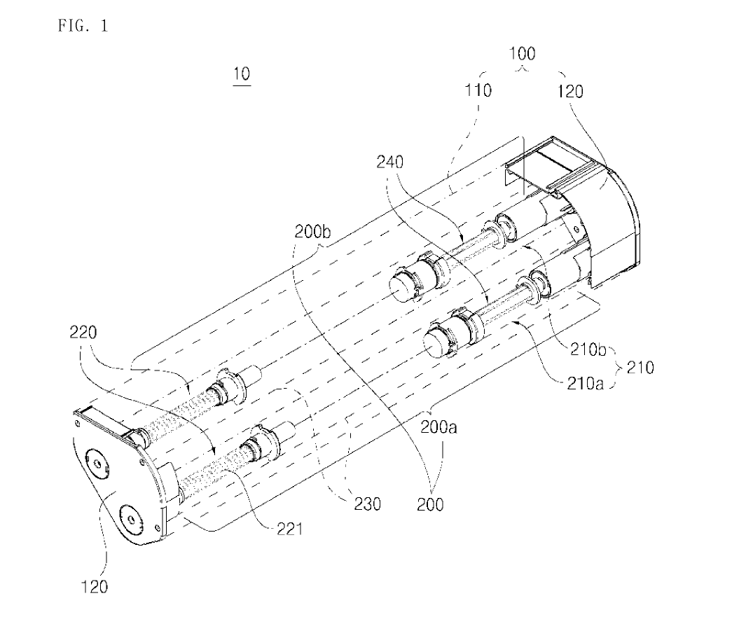

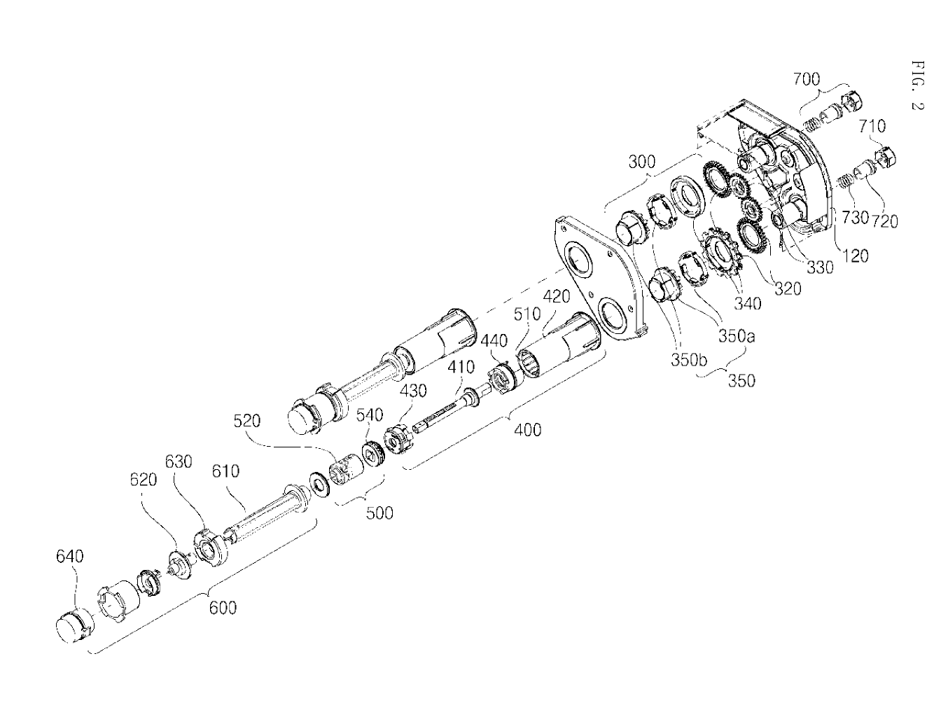

As illustrated in FIGS. 1 to 8A and 8B, a dual screen roll blind 10 of the present disclosure is configured to include two winding roll bodies 200 which are roll-stored so as enable light blocking or light shielding by adjusting vertical positions of two screens 210, a blind housing 100 having an end plate 120, and a gear unit 300 operating the winding roll bodies 200 for drawing/storing the screens 210.

In other words, the blind housing 100 as a general structure of a blind includes a roll cover 110 installed at an upper portion of a window and having an accommodation space of a predetermined length and the end plates 120 formed at both ends of the roll cover 110.

In addition, two winding roll bodies 200 are divided into first and second winding roll bodies 200a and 200b having the same structure and accommodated in the receiving space of the roll cover 110 at a distance from each other, and are rotatably installed at both ends of the end plates, and first and second screens 210a and 210b are roll-stored in two winding roll bodies 200, respectively so that the positions of the first and second screens 210a and 210b are vertically adjusted.

Last, the gear unit 300 is provided between the first and second winding roll bodies 200a and 200b and either one of the end plates 120.

In this case, a driving gear 320 is installed, which is axially coupled to the first winding roll body 200a and chain-connected to a ball chain 310 to rotatably operate the first winding roll body 200a by rotation driving.

A first switching connector 350a for transferring rotation in only one direction of rotational directions of the driving gear 320 to the first winding roll body 200a is positioned between the first winding roll body 200a and the driving gear 320.

In addition, a driven gear 340 is installed, which receives rotational force of the driving gear to rotatably operate the second winding roll body 200b by an intermediate gear 330 which is axially coupled to the second winding roll body 200b to gear-engaging the first and second winding roll bodies 200a and 200b along the end plate 120.

In this case, a second switching connector 350b is positioned between the second winding roll body 200b and the driven gear 340, which transfers only the rotational force of the driven gear 340 that rotates in a direction opposite to the rotational direction of the driving gear 320 to the second winding roll body 200b.

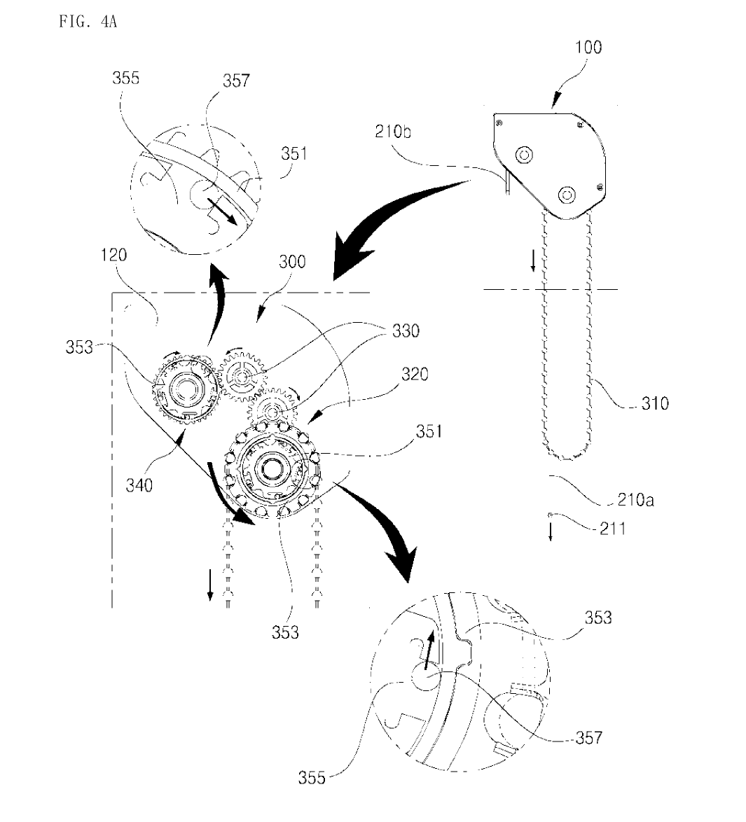

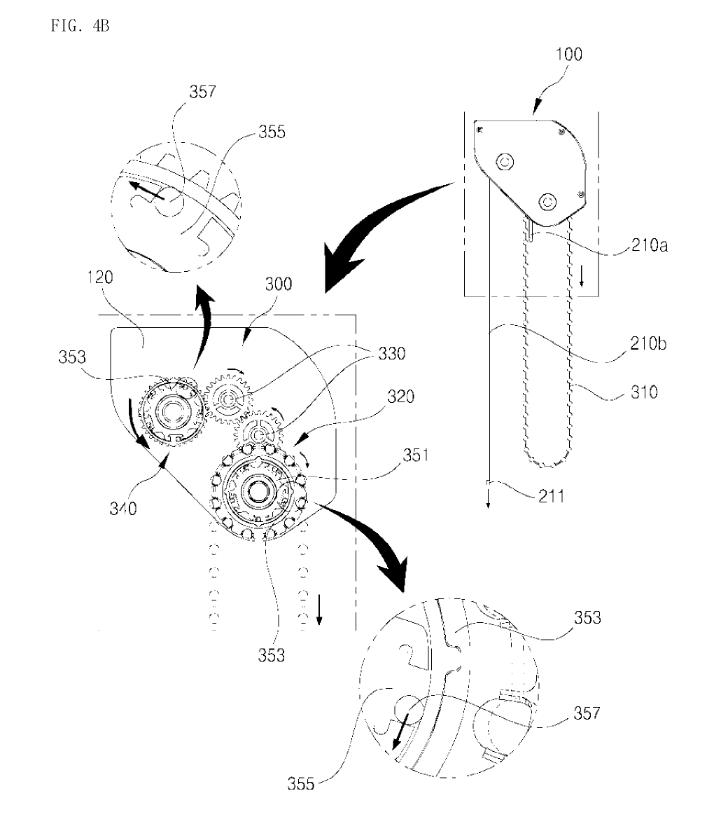

That is, for the gear unit 300, referring to FIGS. 4A and 4B, a user first selects any one of two screens to determine a pulling position of the ball chain.

First, according to FIG. 4A, when the user selects to unroll the first screen 210a at a portion where the driving gear 320 is positioned, the ball chain 310 positioned inside between the ball chains 310 which extended in both directions along a circle is pulled to rotate the driving gear 320 counterclockwise.

In this case, when an outer wheel 351 of a first switching connector 350a connected to the driving gear 320 rotates together with the driving gear 320 and a rolling pin 357 positioned inside the first switching connector 350a moves in a rolling manner, the rolling pin 357 moves to a narrow gap of a taper piece 355 along the taper piece 355 formed in an inner wheel 353 and the inner wheel 353 is thus restrained to rotate together with the outer wheel 351 through a fitting action to transfer the rotational force of the driving gear 320 to the first winding roll body 200a through the first switching connector 350a.

Meanwhile, the rotational force is transferred to the driven gear 340 through the intermediate gear 330 gear-connected to the driving gear 320 with the rotation of the driving gear 320 and the driven gear 340 rotates in a clockwise direction which is the opposite direction to the driving gear 320.

In this case, while the outer wheel 351 of a second switching connector 350b connected to the driven gear 340 rotates together with the driven gear 340 and the rolling pin 357 positioned inside the second switching connector 350b moves in the rolling manner, the rolling pin 357 moves to a broad gap of the taper piece 355 along the taper piece 355 formed in the inner wheel 353 and the taper piece 355 does not thus restrain the rolling pin 357. Therefore, even though the outer wheel 351 rotates, the inner wheel 353 does not rotate together, and as a result, the rotational force is not transferred to the second winding roll body 200b.

On the contrary, according to FIG. 4B, when the user selects to unroll the second screen 210b at the portion where the driving gear 320 is positioned, the ball chain 310 positioned outside between the ball chains 310 which extended in both directions along the circle is pulled to rotate the driving gear 320 clockwise.

In this case, while the outer wheel 320 of the first switching connector 350a connected to the driving gear 320 rotates together with the driving gear 320 and the rolling pin 357 positioned inside the first switching connector 350a moves in the rolling manner, the rolling pin 357 moves to the broad gap of the taper piece 355 along the taper piece 355 formed in the inner wheel 353 and the taper piece 355 does not thus restrain the rolling pin 357. Therefore, even though the outer wheel 351 rotates, the inner wheel 353 does not rotate together, and as a result, the rotational force is not transferred to the first winding roll body 200a.

Meanwhile, the rotational force is transferred to the driven gear 340 through the intermediate gear 330 gear-connected to the driving gear 320 with the rotation of the driving gear 320 and the driven gear 340 rotates in a counterclockwise direction which is the opposite direction to the driving gear 320.

In this case, while the outer wheel 351 of the second switching connector 350b connected to the driven gear 340 rotates together with the driven gear 340 and the rolling pin 357 positioned inside the second switching connector 350b moves in the rolling manner, the rolling pin 357 moves to the narrow gap of the taper piece 355 along the taper piece 355 formed in the inner wheel 353 and the inner wheel 353 is thus restrained to rotate together with the outer wheel 351 through the fitting action to transfer the rotational force of the driving gear 320 to the second winding roll body 200b through the second switching connector 350b.

Next, referring to FIGS. 1 to 3A and 3B, the winding roll body 200 divided into the first and second winding roll bodies 200a and 200b is basically constituted by a winding roll 230 in which the screen 210 is roll-stored, a winding rod 240 coupled and gear-engaged to one end of the winding roll 230, and a support rod 220 coupled to the other end of the winding roll 30 and supporting the winding roll 230.

Herein, the winding roll 230 is provided so as to be able to draw and store the screen 210 having a weight bar 211 by rotating the screen 210 in a roll manner.

In addition, the winding rod 240 are fitted to one end of the winding roll 230 and connected to the driving gear 320 or the driven gear 340 so as to be rotatably operated by the rotational force transferred from the driving gear 320 or the driven gear 340.

Further, the support rod 220 is provided on the opposite endplate 120 in correspondence with the winding rod 240 and supports the winding roll 230 which rotates while being fitted into the other end of the winding roll 230.

Consequently, the roll-stored screen 210 is drawn by rotating the winding roll 230 by the driving gear 320 or the driven gear 340 or by the rotational operation of the winding rod 240, and the rotational force of the winding roll 230 is accumulated through the return spring 221 incorporated in the support rod 220, and thereafter, elastically restored to roll-store the screen 210 in the winding roll 230.

Herein, the winding rod 240 includes, from the switching connector 350 divided into the first and second switching connectors 350a and 350b along a central axis 410 sequentially, a clutch unit 400 selectively controlling the rotational force only at the time of transferring the rotational force transferred from the driving gear 320 or the driven gear 340 through the switching connector 350 to the winding roll 230, a stopper unit 500 restraining/releasing a current position of the screen 210 due to restoration force of the return spring 221 when the screen stops at a position desired by the user during a drawing operation of the screen 210 through rotation of the winding roll 230, and a limit unit 600 completing roll-storing by stopping the rotation of the winding roll 230 when the screen 210 reaches an initial position in the case where the screen 210 is roll-stored by rotating the winding roll 230 due to the restoration force of the return spring through releasing the stopper unit 500.

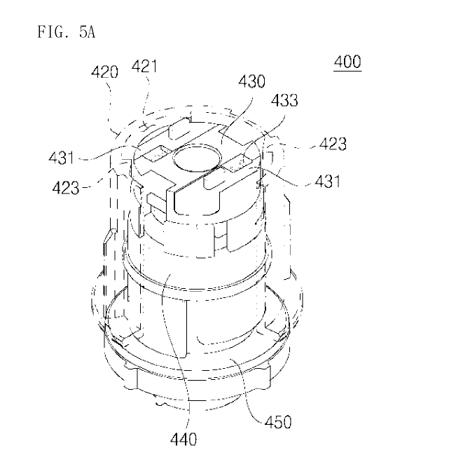

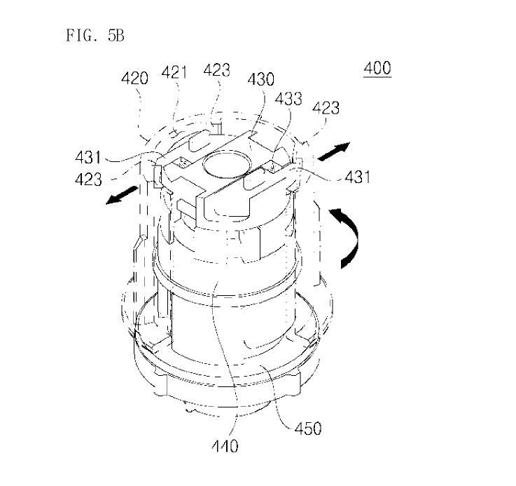

In this case, referring to FIGS. 5A and 5B, the clutch unit 400 includes a clutch plug 420 fitted into an inner diameter of the winding roll 230 having a cylindrical shape in a socket manner and having a clutch socket unit 421 therein, a rear clutch 430 having a slide key 431 inserted into the clutch socket unit 421 and elastically supported by a support spring 433, a front clutch 440 engaged with a clutch surface through mutual correspondence to correspond to the rear clutch 430, and a driving rotation body 450 transferring the rotational force transferred by direct coupling to the switching connector 350 to the front clutch 440 and when the front clutch 440 is rotated simultaneously with rotation of the driving rotation body 450 with rotation of the switching connector 350, the slide key 431 of the rear clutch 430 engaged with the front clutch 440 is fixed in close contact with an inner suspension protrusion 423 of the clutch plug 420 to restrain the switching connector 350, the driving rotation body 450, the front clutch 440, the rear clutch 430, and the clutch plug 420 by a single body, thereby rotatably operating the winding roll 230.

That is, when the rotational force is transferred to the clutch unit 400 through the switching connector 350, the driving rotation body 450 and the front clutch 440 are sequentially engaged and rotated, and last, the slide key 431 of the rear clutch 430 is forcibly projected outward by the front clutch 440 to be suspended on a suspension projection 423 of the clutch socket unit 421 and sequentially rotated together.

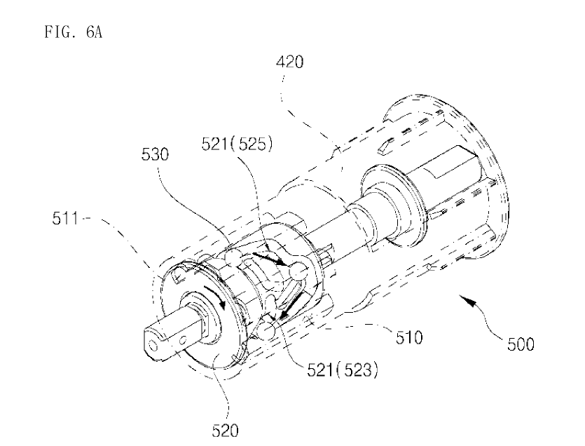

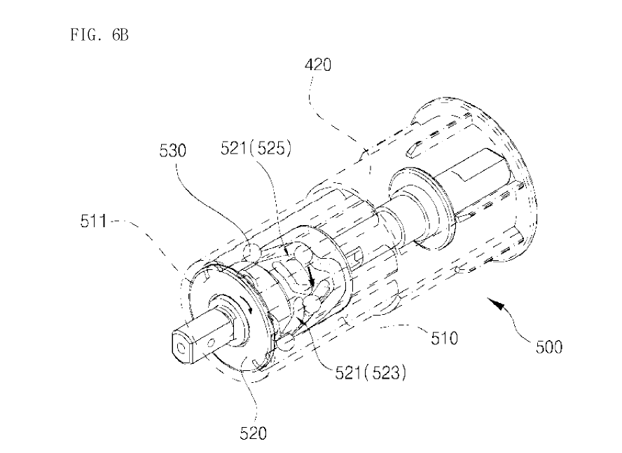

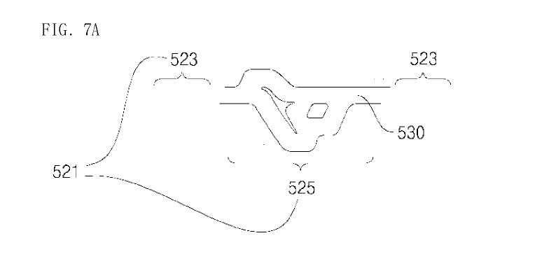

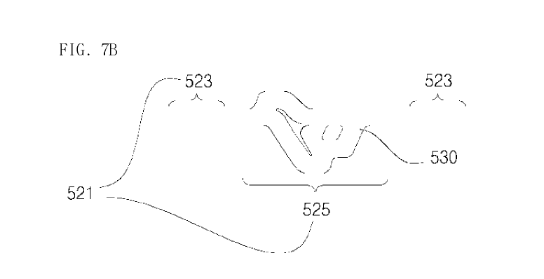

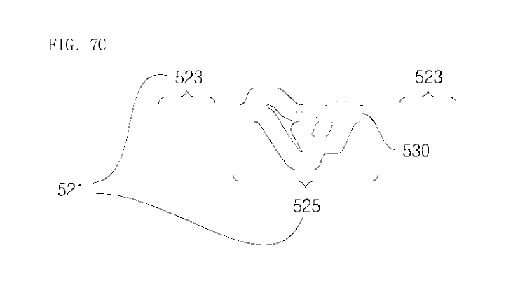

Meanwhile, referring to FIGS. 6A and 6B and 7A to 7C, the stopper unit 500 includes a stopper socket unit 510 having multiple ball guide grooves 511 having a predetermined length, which form an inner surface in a spline manner at an opposite side of the clutch plug 420 to correspond to the clutch socket unit 421, a stopper body 520 having a line groove 521 inserted into the stopper socket unit 510 and having a linear section 523 and a suspension section having a geometric stop on the circumference on an outer surface, and a bead-shaped ball key 530 repeatedly restraining/releasing the position of the screen 210 while moving in the linear section 523 and the suspension section 525 in a movement direction of the screen 210 provided in each of the ball guide groove 511 and the line groove 521 and drawn from/stored in the winding roll 230.

In this case, referring to FIGS. 7A to 7C, in FIG. 7A, while the clutch plug 420 is rotated by driving the driving gear 320 or the driven gear 340, each ball key 530 moves in the opposite direction to the suspension section 525 at a low speed by the ball guide groove 511 provided in the stopper socket unit 510 and smoothly rotated without being suspended on a suspension portion to draw the screen 210 to the winding roll 230, in FIG. 7B, when the user stops driving through the ball chain, the ball key 530 positioned in the suspension section 525 while slightly moving in the opposite direction temporarily by the restoration force of the return spring 221 provided in the support rod 220 is fitted in the suspension portion and fixed while the screen 210 is unrolled, and in FIG. 7C, when the user slightly pulls down and releases the weight bar 211 in order to store the unrolled screen 210, while the screen 210 is stored in the winding roll 230 by rotating at a higher speed than a case where the screen 210 is drawn by the restoration force of the return spring 221, the ball key 530 smoothly rotates along the linear section 523 regardless of the suspension section 525, and as a result, the screen 210 is roll-stored.

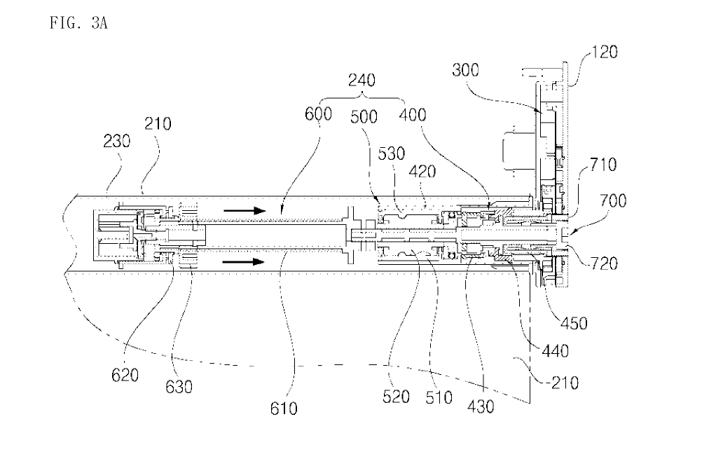

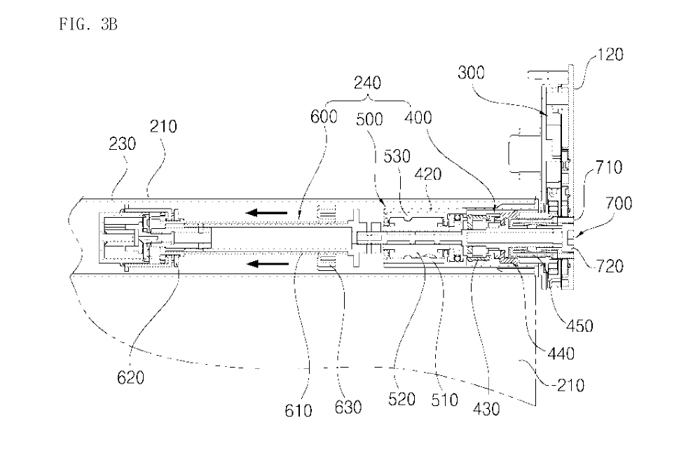

Last, referring to FIGS. 3A and 3B, the limit unit 600 includes a screw rod 610 extended from the stopper body 520 in a longitudinal direction and having a thread on an outer circumferential surface thereof, a finishing plate 620 coupled to an end of the screw rod 610, and a limiter 630 fastened to the screw rod 610 in a nut shape and reciprocating on the thread in the longitudinal direction of the screw rod 610 with rotation of the screw rod 610, and when the winding roll 230 rotates in order to draw the screen 210, while the screw rod 610 rotates together, the limiter 630 performs positional movement of being gradually away from an initial position of the finishing plate 620 along the thread and when the winding roll 230 rotates in a reverse direction by roll-storing the screen 210, while the screw rod 610 rotates together, the limiter 630 returns to the initial position where the finishing plate 620 is present to stop a storing operation of the screen 210 when the limiter 630 is in contact with the finishing plate 620.

In this case, a speed reducer 640 reducing a rotational speed of the winding roll 230 is further provided at the end of the screw rod 610 to which the finishing plate 620 is coupled in order to prevent a safety accident and breakage caused by high-speed rotation of the winding roll 230 and rapid roll-storing of the screen 210 due to the restoring force of the return spring 221.

The speed reducer 640 is preferably formed in a tank shape having hydraulic oil.

In addition, when installing in the window or during using the dual screen roll blind 10 is provided with the end plate 120, the driving gear 320 or the driven gear 340, and the first and second winding roll bodies 200a and 200b through penetration coupling, a setting adjuster 700 for the user to adjust the screen 210 to the initial position by directly rotating the first and second winding roll bodies 200a and 200b is further provided.

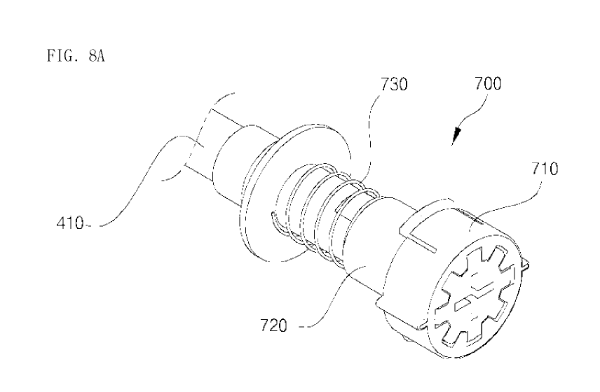

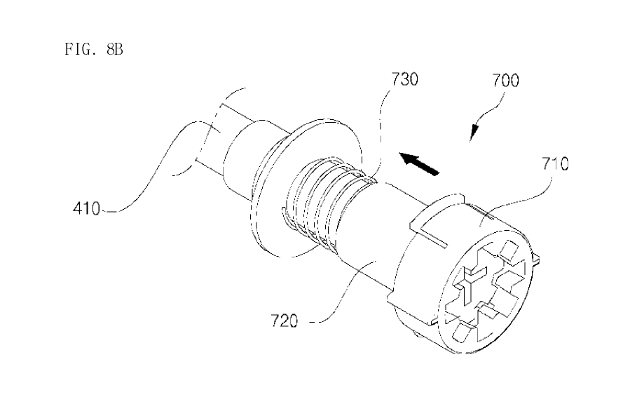

Referring to FIGS. 8A and 8B, in the setting adjuster 700, a fixed spline 710 having a spline shape is fixed to a coupling hole of the end plate 120 on an inner side and an operating spline 720 having the spline shape is provided on an outer side in close contact with the end of the central axis 410 on an outer side while being engaged with the fixed spline 710 by a close contact spring 730.

In this case, the user disengages and rotates the operating spline 720 by pushing the operation spline 720 to the inside of the end plate 120 by using a separate jig or a cross screwdriver, and as a result, the winding roll body 200 rotates through rotation of the central axis 410 to set the initial position of the screen 210.

Therefore, a positional change may be set again, which occurs due to lowering of the restoration force of the return spring 221 or a slip between the respective units during long-term use.

According to the present disclosure, it is possible to selectively draw two screens, to rapidly store the unrolled screen through automatic return and ensure child safe by the return spring and the limiter, and to achieve an increased scarcity value by giving novelty, and a light transmitting property, and a light shielding property of the screen according to the taste of the user.

Terms and words used in the present specification and claims should not be interpreted as being limited to typical or dictionary meanings, but should be interpreted as having meanings and concepts which comply with the technical spirit of the present disclosure, based on the principle that an inventor can appropriately define the concept of the term to describe his/her own invention in the best manner.

Accordingly, configurations illustrated in the drawings and exemplary embodiments disclosed in the present specification are only the most preferred embodiment of the present disclosure and do not represent all of the technical spirit of the present disclosure, and thus it is to be understood that various equivalents and modified examples, which may replace the configurations, are possible when filing the present application.

What is claimed is:

1. A dual screen roll blind 10 including two winding roll bodies 200 which are roll-stored so as enable light blocking or light shielding by adjusting vertical positions of two screens 210, the dual screen roll blind comprising:
a blind housing 100 including a roll cover 110 installed at an upper portion of a window and having an accommodation space of a predetermined length and the end plates 120 formed at both ends of the roll cover 110;
first and second winding roll bodies 200a and 200b accommodated in the receiving space of the roll cover 110 at a distance from each other, and rotatably installed at both ends of the end plates, and roll-storing first and second screens 210a and 210b so that the positions of the first and second screens 210a and 210b are vertically adjusted;
a gear unit 300 provided between the first and second winding roll bodies 200a and 200b and either one of the end plates 120 and including a driving gear 320 is installed, which is axially coupled to the first winding roll body 200a and chain-connected to a ball chain 310 to rotatably operate the first winding roll body 200a by rotation driving, a first switching connector 350a provided between the first winding roll body 200a and the driving gear 320 and transferring rotation in only one direction of rotational directions of the driving gear 320 to the first winding roll body 200a, a driven gear 340 receiving rotational force of the driving gear to rotatably operate the second winding roll body 200b by an intermediate gear 330 which is axially coupled to the second winding roll body 200b to gear-engaging the first and second winding roll bodies 200a and 200b along the endplate 120, and a second switching connector 350b provided between the second winding roll body 200b and the driven gear 340 and transferring only the rotational force of the driven gear 340 that rotates in a direction opposite to the rotational direction of the driving gear 320 to the second winding roll body 200b,
wherein the winding roll body 200 divided into the first and second winding roll bodies 200a and 200b includes
a winding roll 230 drawing and storing the screen 210 having a weight bar 211 by rotating the screen 210 in a roll manner,
a winding rod 240 fitted to one end of the winding roll 230 and connected to the driving gear 320 or the driven gear 340 so as to be rotatably operate by the rotational force transferred from the driving gear 320 or the driven gear 340, and
a support rod 220 provided on the opposite end plate 120 in correspondence with the winding rod 240 and supporting the winding roll 230 which rotates while being fitted into the other end of the winding roll 230, and
the roll-stored screen 210 is drawn by rotating the winding roll 230 by the driving gear 320 or the driven gear 340 or by the rotational operation of the winding rod 240, and the rotational force of the winding roll 230 is accumulated through the return spring 221 incorporated in the support rod 220, and thereafter, elastically restored to roll-store the screen 210 in the winding roll 230.

2. The dual screen roll blind according to claim 1, wherein the winding rod 240 includes sequentially from a switching connector 350 divided into the first and second switching connectors 350a and 350b along a central axis 410,
a clutch unit 400 selectively controlling the rotational force only at the time of transferring the rotational force transferred from the driving gear 320 or the driven gear 340 through the switching connector 350 to the winding roll 230,
a stopper unit 500 restraining/releasing a current position of the screen 210 due to restoration force of the return spring 221 when the screen stops at a position desired by the user during a drawing operation of the screen 210 through rotation of the winding roll 230, and
a limit unit 600 completing roll-storing by stopping the rotation of the winding roll 230 when the screen 210 reaches an initial position in the case where the screen 210 is roll-stored by rotating the winding roll 230 due to the restoration force of the return spring through releasing the stopper unit 500.

3. The dual screen roll blind according to claim 2, wherein the clutch unit 400 includes
a clutch plug 420 fitted into an inner diameter of the winding roll 230 having a cylindrical shape in a socket manner and having a clutch socket unit 421 therein,
a rear clutch 430 having a slide key 431 inserted into the clutch socket unit 421 and elastically supported by a support spring 433,
a front clutch 440 engaged with a clutch surface through mutual correspondence to correspond to the rear clutch 430, and
a driving rotation body 450 transferring the rotational force transferred by direct coupling to the switching connector 350 to the front clutch 440, and
when the front clutch 440 is rotated simultaneously with rotation of the driving rotation body 450 with rotation of the switching connector 350, the slide key 431 of the rear clutch 430 engaged with the front clutch 440 is fixed in close contact with an inner suspension protrusion 423 of the clutch plug 420 to restrain the switching connector 350, the driving rotation body 450, the front clutch 440, the rear clutch 430, and the clutch plug 420 by a single body, thereby rotatably operating the winding roll 230.

4. The dual screen roll blind according to claim 3, wherein the stopper unit 500 includes
a stopper socket unit 510 a stopper body 520 having multiple ball guide grooves 511 having a predetermined length, which form an inner surface in a spline manner at an opposite side of the clutch plug 420 to correspond to the clutch socket unit 421,
a stopper body 520 having a line groove 521 inserted into the stopper socket unit 510 and having a linear section 523 and a suspension section having a geometric stop on the circumference on an outer surface, and
a bead-shaped ball key 530 repeatedly restraining/releasing the position of the screen 210 while moving in the linear section 523 and the suspension section 525 in a movement direction of the screen 210 provided in each of the ball guide groove 511 and the line groove 521 and drawn from/stored in the winding roll 230.

5. The dual screen roll blind according to claim 4, wherein the limit unit 600 includes
a screw rod 610 extended from the stopper body 520 in a longitudinal direction and having a thread on an outer circumferential surface thereof,
a finishing plate 620 coupled to an end of the screw rod 610, and
a limiter 630 fastened to the screw rod 610 in a nut shape and reciprocating on the thread in the longitudinal direction of the screw rod 610 with rotation of the screw rod 610, and
when the winding roll 230 rotates in order to draw the screen 210, while the screw rod 610 rotates together, the limiter 630 performs positional movement of being gradually away from an initial position of the finishing plate 620 along the thread and when the winding roll 230 rotates in a reverse direction by roll-storing the screen 210, while the screw rod 610 rotates together, the limiter 630 returns to the initial position where the finishing plate 620 is present to stop a storing operation of the screen 210 when the limiter 630 is in contact with the finishing plate 620.

6. The dual screen roll blind according to claim 5, wherein a speed reducer 640 reducing a rotational speed of the winding roll 230 is further provided at the end of the screw rod 610 to which the finishing plate 620 is coupled in order to prevent a safety accident and breakage caused by high-speed rotation of the winding roll 230 and rapid roll-storing of the screen 210 due to the restoring force of the return spring 221.

7. The dual screen roll blind according to claim 1, wherein when installing in the window or during using the dual screen roll blind 10 is provided with the end plate 120, the driving gear 320 or the driven gear 340, and the first and second winding roll bodies 200a and 200b sequentially through penetration coupling respectively, a setting adjuster 700 for the user to adjust the screen 210 to the initial position by directly rotating the first and second winding roll bodies 200a and 200b is further provided.
